(19) United States
(12) Patent Application Publication
(10) Pub. No.: US 2013/0181798 A1
(43) Pub. Date: Jul. 18, 2013

(54) POWER SUPPLY APPARATUS AND ITS MANUFACTURING METHOD

(71) Applicants: Akitaka KANAMORI, Shizuoka-shi (JP); Takahiro KADOWAKI, Shizuoka-shi (JP)

(72) Inventors: Akitaka KANAMORI, Shizuoka-shi (JP); Takahiro KADOWAKI, Shizuoka-shi (JP)

(21) Appl. No.: 13/743,645

(22) Filed: Jan. 17, 2013

(30) Foreign Application Priority Data
Jan. 18, 2012 (JP) 2012-008001

(51) Int. Cl. H01F 27/06

(52) U.S. Cl. CPC H01F 27/06
USPC 336/65; 29/602.1

(57) ABSTRACT

A power supply apparatus is configured to supply power to a load mounted on a vehicle. The power supply apparatus includes a case and a transformer disposed inside the case in a fixed manner. The transformer includes a base made of a resin and fixed to the case, a core attached to the base, a winding wound on the core, and a metal terminal attached to the base. The metal terminal has a solder connection portion to which an end portion of the winding is soldered. The base has a resin melted portion adhered, after being melted, to a portion of the metal terminal.

### CROSS-REFERENCE TO RELATED APPLICATION

The present application claims priority from Japanese Patent Application No. 2012-008001 filed on Jan. 18, 2012, the entire content of which is incorporated herein by reference.

1. Field of Invention

The present invention relates to a power supply apparatus configured to supply power to an electric load device mounted on a vehicle, and a method of manufacturing the power supply apparatus.

2. Description of Related Art

Being heavier than other electronic devices, transformers need to be firmly fixed so that they do not move. For example, according to a related art method, a transformer is mounted on a printed board using one or more dummy lead terminals (see, e.g., JP 2003-168609 A).

However, large vibration frequently acts on a transformer mounted on a vehicle. Therefore, fixing a transformer inside a case to the case via a printed board may not provide sufficient fixing strength for the transformer. Further, an electric wire extending from the transformer is fixed via a metal terminal mounted on the printed board made of a resin. Therefore, the metal terminal may fall off due to the vibration.

### BRIEF SUMMARY

Illustrative aspects of the present invention provide a power supply apparatus in which a transformer and a metal terminal thereof are securely attached.

According to an illustrative aspect of the present invention, a power supply apparatus is provided. The power supply apparatus is configured to supply power to a load mounted on a vehicle. The power supply apparatus includes a case and a transformer disposed inside the case in a fixed manner. The transformer includes a base made of a resin and fixed to the case, a core attached to the base, a winding wound on the core, and a metal terminal attached to the base. The metal terminal has a solder connection portion to which an end portion of the winding is soldered. The base has a resin melted portion adhered, after being melted, to a portion of the metal terminal

According to another illustrative aspect of the present invention, a method of manufacturing a power supply apparatus is provided. The power supply apparatus is configured to supply power to a load mounted on a vehicle. The method includes providing a transformer having a base made of a resin, a core attached to the base, a winding wound on the core, and a metal terminal attached to the base, and fixing the base to a case such that the transformer is disposed inside the case in a fixed manner The step of providing the transformer includes soldering an end portion of the winding to a solder connection portion of the metal terminal such that the resin is melted by heat applied during the soldering, thereby forming a resin melted portion of the base. The resin melted portion is adhered to a portion of the metal terminal.

Other aspects and advantages of the invention will be apparent from the following description, the drawings and the claims.

### BRIEF DESCRIPTION OF THE DRAWINGS

FIG. 1 is a sectional view of a power supply apparatus according to an exemplary embodiment of the present invention;

FIG. 2 is a sectional view of a transformer of the power supply apparatus shown in FIG. 1;

FIG. 3 is a sectional view of the transformer taken along the line III-III of FIG. 2;

FIG. 4 is a top view of the transformer viewed in the direction IV of FIG. 2;

FIG. 5 is a schematic diagram illustrating an assembling process of the transformer;

FIG. 6 is an enlarged perspective view illustrating how a winding is connected to the metal terminal; and

FIG. 7 is a schematic diagram illustrating how the transformer and an LED lighting circuit are connected to each other by a ribbon.

### DETAILED DESCRIPTION

Hereinafter, exemplary embodiments of the present invention will be described in detail with reference to the drawings. However, the following exemplary embodiments do not limit the scope of the claimed invention.

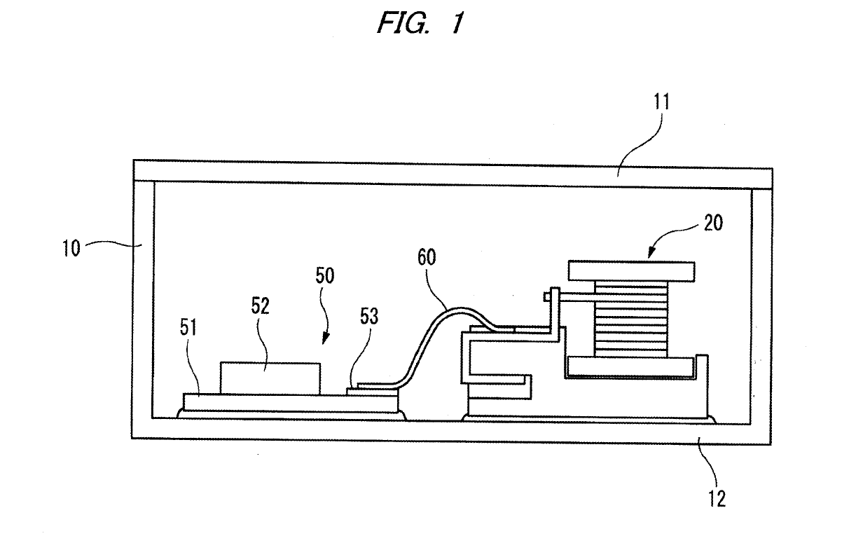

FIGS. 1 to 4 illustrate a power supply apparatus according to an exemplary embodiment of the invention. The power supply apparatus is adapted to be mounted on a vehicle. The power supply apparatus receives power from a voltage source of, for example, 12 V, increases the voltage of the power, and supplies the power to an LED of a vehicle lamp. As shown in FIG. 1, the power supply apparatus has a metal case 10 closed by a cover 11, a transformer 20 disposed inside the case 10, and an LED lighting circuit 50 (an example of an electronic component) fixed to the case 10.

The LED lighting circuit 50 receives the power from the transformer 20 with increased voltage, and supplies the power to the LED to light the LED. The LED lighting circuit 50 includes a ceramic substrate 51 bonded to the case 10, and a control circuit 52 mounted on the substrate 51. The substrate 51 is firmly attached to the bottom surface of the case 10 in a fixed manner, whereby heat transfer from the LED lighting circuit 50 to the metal case 10 is facilitated. The LED lighting circuit 50 is electrically connected to the transformer 20 via a conductive ribbon 60 (an example of an input-output line) extending from an electrode pad 53, which is a metal member, provided on the substrate 51. The ribbon 60 is a band-shaped metal member.

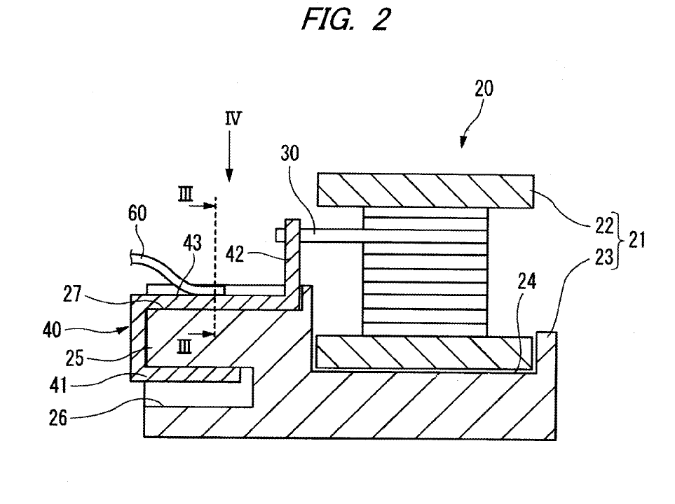

FIG. 2 is an enlarged sectional view of the transformer 20 shown in FIG. 1. The transformer 20 receives power from an external power source, increases the voltage of the power, and supplies the power to the LED lighting circuit 50. The transformer 20 has base members 21 including a metal core 22 and a resin base 23, conductive windings 30 wound on the core 22, and a metal terminal 40 attached to the base 23. The base 23 is fixed to the bottom surface of the case 10 by a fixing means such as an adhesive. The resin material of the base 23 is has a softening temperature that is lower than the melting temperature of the solder.

The base 23 has a core receiving portion 24 and a terminal holding portion 25 extending sideways from the core receiving portion 24. The core receiving portion 24 has a recessed top surface. The core 22 is inserted in the core receiving portion 24 and is bonded to the core receiving portion 24. A side surface of the base 23 is formed with an insertion recess 26 below the terminal holding portion 25. The top surface of the terminal holding portion 25 is formed with a terminal receiving recess 27 in which the metal terminal 40 is fitted.

The core 22 is a cylindrical member, and is fixed to the core receiving portion 24 such that its center axis extends in the top-bottom direction. The core 22 is made of a soft magnetic material such as iron.

A primary winding electrically connected to the external power source and a secondary winding electrically connected to the LED lighting circuit 50 are wound on the core 22. These windings 30 are made of a conductive material (metal material), and has a ribbon-shape or a band-shape. An insulating coating is formed on the surface of each of the windings 30. The ribbon-shaped windings 30 are wound on the core 22 such that their wider surfaces face the top-bottom direction, thereby forming the windings 30 with low height while suppressing the electric resistance.

The metal terminal 40 is a conductive member formed by bending a metal plate. The metal terminal 40 includes an attachment portion 41 at the bottom, a solder connection portion 42 at the top, and a flat ribbon connecting portion 43 extending between the attachment portion 41 and the solder connection portion 42.

The attachment portion 41 is formed by bending a lower portion of the metal terminal 40. A distal end of the attachment portion 41 is inserted in the insertion recess 26 of the base 23, so that the attachment portion 41 and the ribbon connecting portion 43 clamps the terminal holding portion 25. In this manner, the metal terminal 40 can be fixed to the base 23 temporarily. To attach the metal terminal 40 to the base 23 in a stable manner, the thickness of the terminal holding portion 25 is slightly greater than the distance between the attachment portion 41 and the ribbon connecting portion 43.

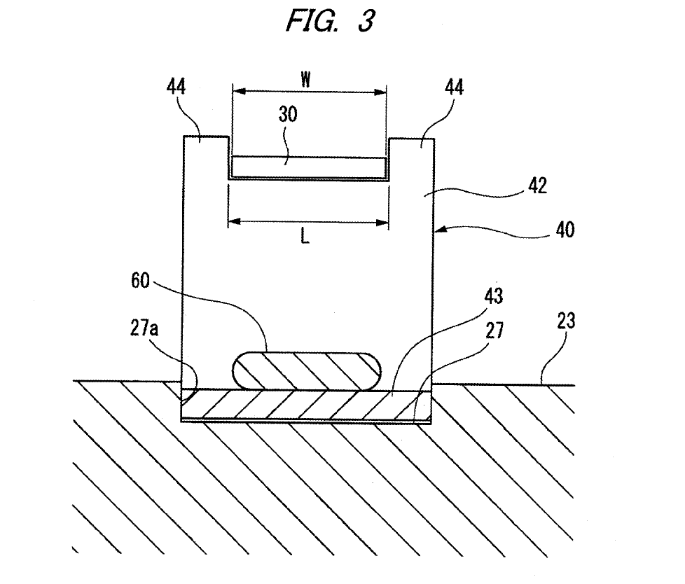

As shown in FIG. 2, the solder connection portion 42 forming the upper end of the metal terminal 40 is provided to extend upwards from the ribbon connecting portion 43. As shown in FIG. 3, illustrating a sectional view of a portion near the solder connection portion 42 taken along line III-III in FIG. 2, a distal end portion of the solder connection portion 42 is formed with a pair of temporary fixing projections 44.

The temporary fixing projections 44 project in the extending direction of the solder connection portion 42. The distance L between the temporary fixing projections 44 is equal to or slightly greater than the width W of the winding 30. Thus, the winding 30 can be fixed temporarily to the solder connection portion 42 by pushing an end portion of the winding 30 into a space between the temporary fixing projections 44 from above. The winding 30 is fixed to the metal terminal 40 by soldering in a state in which it is temporarily fixed to the metal terminal 40.

The ribbon connecting portion 43 has a flat surface, and extends between the attachment portion 41 and the solder connection portion 42 and parallel to the attachment portion 41. When the attachment portion 41 is inserted into the insertion recess 26, the terminal holding portion 25 is clamped between the ribbon connecting portion 43 and the attachment portion 41. The metal terminal 40 is thus attached to the base 23.

The ribbon connecting portion 43 is coated (plated) with a Ni-based material, whereby the adhesion between the ribbon connecting portion 43 and the ribbon 60 is improved. The ribbon connecting portion 43 may be coated (plated) with a material containing, as a main component, Al, Cu, Ag or Au, instead of Ni.

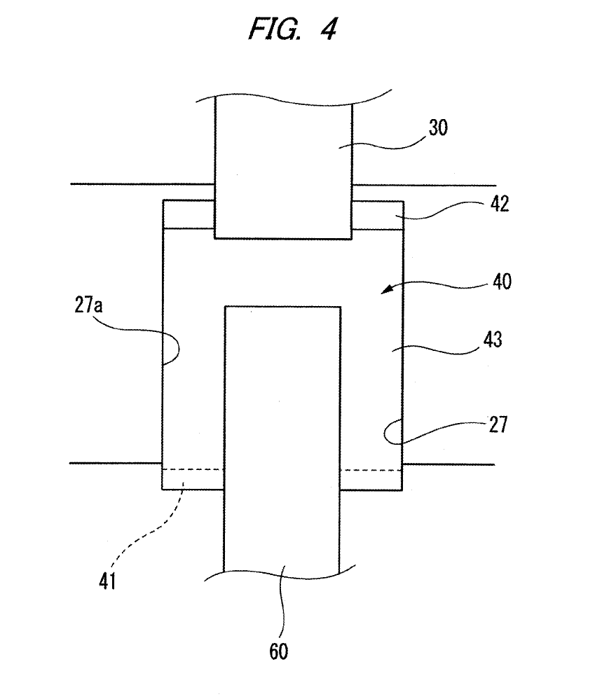

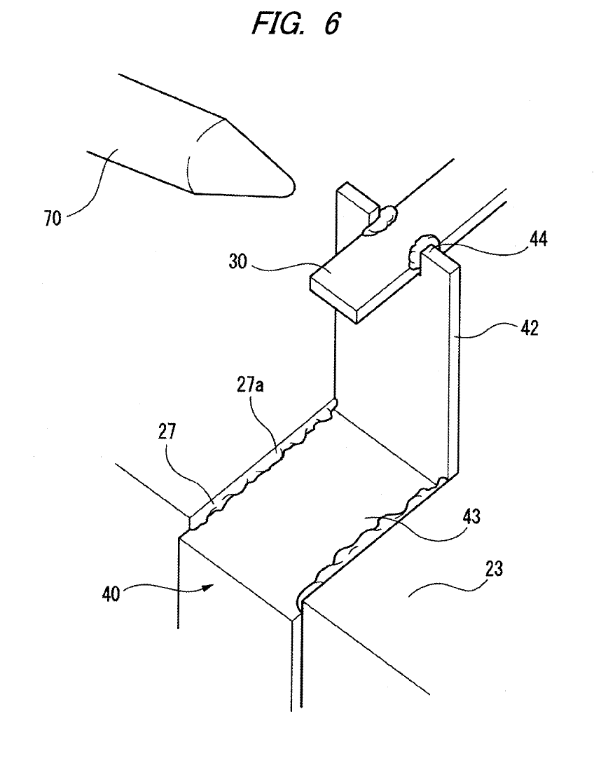

FIG. 4 is a top view of a region around the ribbon connecting portion 43, viewed in the direction IV in FIG. 2. As shown in FIGS. 3 and 4, the top surface of the terminal holding portion 25 of the base 23 is formed with the terminal receiving recess 27 to accommodate the ribbon connecting portion 43 of the metal terminal 40. The terminal receiving recess 27 is formed as a grove having a depth that is greater than the thickness of the metal terminal 40 (see FIG. 6).

As shown in FIG. 4, the width of the terminal receiving recess 27 is equal to or slightly greater than the width of the metal terminal 40. Thus, when the ribbon connecting portion 43 is fitted into the terminal receiving recess 27, the side walls 27a of the terminal receiving recess 27 come into close contact with the associated side faces of the ribbon connecting portion 43, whereby the metal terminal 40 is temporarily fixed to the base 23.

As shown in FIG. 2, the bottom surface 27b (a support surface) of the terminal receiving recess 27 is flat and supports the flat ribbon connecting portion 43. The bottom surface 27b of the terminal receiving recess 27 is substantially parallel to a surface of a bottom wall 12 of the case 10 (see FIG. 1).

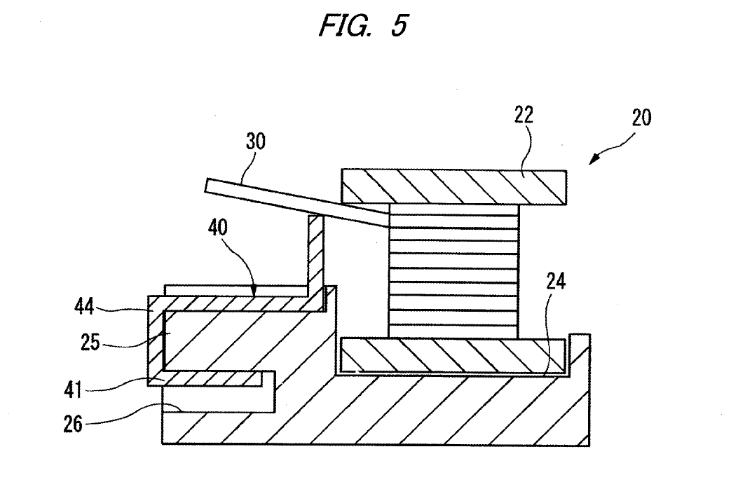

Next, a method of manufacturing the power supply apparatus described above will be described with reference to FIGS. 5 to 7.

First, the LED lighting circuit 50 and the transformer 20 are assembled separately. The LED lighting circuit 50 is provided by mounting the control circuit 52 on the substrate 51 and securing the control circuit 52 to the substrate 51 by securing means such as soldering.

The transformer 20 is produced in the following manner FIG. 5 is a schematic diagram illustrating an assembling process of the transformer 20.

First, as shown in FIG. 5, the core 22 on which the windings 30 are wound is fixed to the core receiving portion 24 of the base 23 by a fixing means such as adhesive.

Then, the metal terminal 40 is attached to the base 23. That is, the distal end portion of the attachment portion 41 of the metal terminal 40 is inserted into the insertion recess 26 of the base 23, so that the terminal holding portion 25 of the base 23 is clamped by the attachment portion 41 and the ribbon connecting portion 43. The metal terminal 40 is thereby fixed to the base 23 temporarily.

Then, the winding 30 is connected to the metal terminal 40. FIG. 6 is an enlarged perspective view of a portion around the metal terminal 40, illustrating how the winding 30 is connected to the metal terminal 40.

First, as shown in FIG. 6, an end portion of the winding 30 is pushed into a space between the pair of temporary fixing projections 44 of the solder connection portion 42 of the metal terminal, whereby the winding 30 is fixed to the metal terminal 40 temporarily. Then, a soldering iron 70 is pressed against the portion near the solder connection portion 42 to heat and to supply a solder to an area between the end portion of the winding 30 and the solder connection portion 42. Accordingly, the end portion of the winding 30 and the metal terminal 40 are soldered.

When soldering the end portion of the winding 30 to the metal terminal 40, heat applied to the solder connection portion 42 is transmitted to the entire metal terminal 40 due to the high thermal conductivity of the metal terminal 40. As a result, the side walls 27a of the terminal receiving recess 27 of the resin base 23 are melted by the heat. When the metal terminal 40 is cooled after the completion of the soldering, the melted side walls 27a become hard again. In this process, the melted portions of the side walls 27a are cured in a state in which they are adhered to a portion of the metal terminal 40.

As described above, during the soldering, the side walls 27a are melted and the melted portions are adhered to the metal terminal 40. When the melted portions of the side walls 27a are cured, they fasten the metal terminal 40 to the base 23. In this manner, the metal terminal 40 is securely fixed to the base 40. To allow the side walls 27a to melt during the soldering, a resin whose softening temperature is lower than the melting temperature of solder is used as the material of the base 23. The assembling of the transformer 20 is thus completed.

Then, the LED lighting circuit 50 and the transformer 20 that have been assembled as described above are fixed to the surface of the bottom wall 12 of the case 10 (see FIG. 1). The transformer 20 is fixed to the case 10 by bonding the base 23 to the surface of the bottom wall 12 of the case 10. Likewise, the LED lighting circuit 50 is fixed to the case 10 by bonding the substrate 51 to the surface of the bottom wall 12 of the case 10.

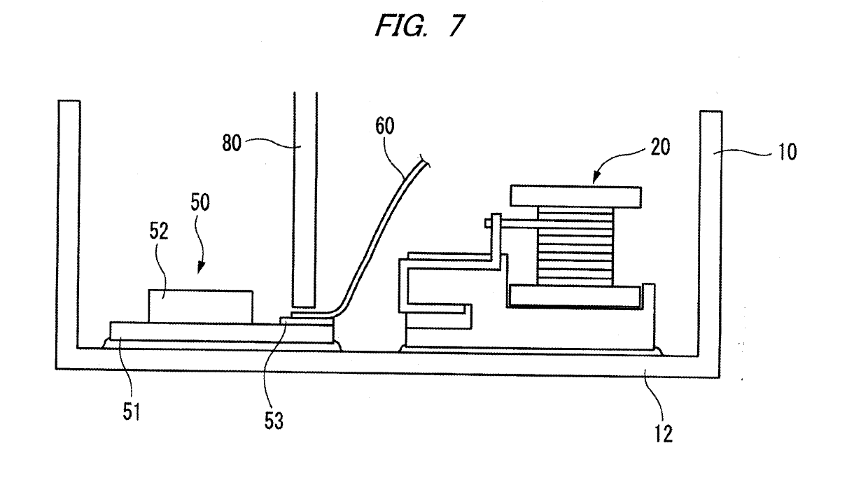

Then, the LED lighting circuit 50 and the transformer 20 are electrically connected to each other by the ribbon 60. FIG. 7 is a schematic diagram illustrating how the LED lighting circuit 50 and the transformer 20 are connected to each other by the ribbon 60.

One end of the ribbon 60 is placed on the electrode pad 53 on the substrate 51, and by using a vibrator 80, ultrasonic vibration is applied to the ribbon 60 while pressing the ribbon 60 against the electrode pad 53. As a result, the ribbon 60 and the electrode pad 53 are ultrasonic-joined to each other due to the friction between the ribbon 60 and the electrode pad 53. This joining using vibration is simple because it is carried out merely by pressing the vibrator 80 against the connecting portion.

The other end of the ribbon 60 is likewise ultrasonic joined to the ribbon connecting portion 43 of the metal terminal 40. Then, the case 10 is closed by the cover 11, whereby the power supply apparatus shown in FIG. 1 is completed.

The ribbon 60 may be ultrasonic-joined first to the ribbon connecting portion 43 of the metal terminal 40 and then to the metal pad 53.

According to the power supply apparatus manufactured by the method described above, the transformer 20 is firmly fixed to the surface of the bottom wall 12 of the case 10 by adhesive and does not come off the case 10 even when vibration is exerted on the vehicle.

During the soldering of the wiring 30 to the metal terminal 40, the side walls 27a of the terminal receiving recess 27 are melted by the heat applied to the metal terminal 40, and the melted portions are cured in a state in which they are adhered to the metal terminal 40. As a result, the metal terminal 40 is firmly fixed to the base 23.

Further, the metal terminal 40 is securely fastened to the base 23 by the side walls 27a. Therefore, the metal terminal 40 is prevented from moving with respect to the base 23 when attaching the ribbon 60 to the metal terminal 40 using the vibrator 80. Therefore, the ribbon 60 is joined to the metal terminal 40 reliably using ultrasonic vibration.

The ribbon 60 is connected to the electrode pad 53 and the metal 40 by ultrasonic joining in a state in which the substrate 51 and the transformer 20 are firmly bonded to the surface of the bottom wall 12 of the case 10. Therefore, the ribbon 60 and each of the electrode pad 53 and the metal 40 are rubbed against each other reliably by the ultrasonic vibration applied to the ribbon 60, whereby the ribbon 60 is joined reliably to the electrode pad 53 and the metal 40.

While the present invention has been described with reference to a certain exemplary embodiment thereof, the scope of the present invention is not limited to the exemplary embodiment described above, and it will be understood by those skilled in the art that various changes and modifications may be made therein without departing from the scope of the present invention as defined by the appended claims.

For example, instead of soldering the winding 30 to the metal terminal 40 using the soldering iron 70, the winding 30 may be soldered to the metal terminal 40 by coating the solder connection portion 42 with solder by heating the entire metal terminal 40 and dipping the solder connection portion 42 and its vicinity into a molten solder bath.

Further, the power supply apparatus is not necessarily configured to supply power to an LED. For example, a power supply apparatus according to one or more exemplary embodiment of the invention may be configured to supply power to a load device incorporated in a vehicle lamp, such as a lighting circuit of a discharge lamp, a motor of a swivel driving device that moves a lamp unit horizontally for horizontal movement of an irradiation beam, or a motor that drives a rotary shade. Also, a power supply apparatus according to another exemplary embodiment of the invention may be configured to supply power to a load device incorporated in other part of the vehicle, such as a motor for driving a movable side mirror.

What is claimed is:

1. A power supply apparatus configured to supply power to a load mounted on a vehicle, the power supply apparatus comprising:
a case; and
a transformer disposed inside the case in a fixed manner,
wherein the transformer comprises:
a base made of a resin and fixed to the case;
a core attached to the base;
a winding wound on the core; and
a metal terminal attached to the base, the metal terminal comprising a solder connection portion to which an end portion of the winding is soldered,
wherein the base comprises a resin melted portion adhered, after being melted, to a portion of the metal terminal.

2. The power supply apparatus according to claim 1, further comprising an input-output line coupled to the transformer,
wherein the metal terminal further comprises a connecting portion to which one end of the input-output line is vibration joined, and
wherein the connecting portion is located adjacent to the melted portion.

3. The power supply apparatus according to claim 2, wherein the base further comprises a support surface configured to support the connecting portion, wherein the support surface is substantially parallel to a bottom surface of the base.

4. The power supply apparatus according to claim 2, further comprising a ceramic substrate comprising a first surface on which an electronic component is mounted and a second surface bonded to a bottom surface of the case, wherein the case is made of a metal.

5. The power supply apparatus according to claim 4, further comprising an electrode provided on the first surface of the substrate, wherein another end of the input-output line is vibration joined to the electrode.

6. A method of manufacturing a power supply apparatus configured to supply power to a load mounted on a vehicle, the method comprising:
providing a transformer comprising a base made of a resin, a core attached to the base, a winding wound on the core, and a metal terminal attached to the base; and
fixing the base to a case such that the transformer is disposed inside the case in a fixed manner,
wherein the providing the transformer comprises soldering an end portion of the winding to a solder connection portion of the metal terminal such that the resin is melted by heat applied during the soldering, thereby forming a resin melted portion of the base, the resin melted portion being adhered to a portion of the metal terminal.
